(19) United States
(12) Patent Application Publication
(10) Pub. No.: US 2014/0178845 A1
(43) Pub. Date: Jun. 26, 2014

(54) System And Method For Electrical Theory Simulator

(71) Applicants: Marty Riesberg, Upper Marlboro, MD (US); William R. Ball, Upper Marlboro, MD (US)

(72) Inventors: Marty Riesberg, Upper Marlboro, MD (US); William R. Ball, Upper Marlboro, MD (US)

(21) Appl. No.: 13/723,184

(22) Filed: Dec. 20, 2012

(51) Int. Cl. G09B 23/18

(52) U.S. Cl. CPC G09B 23/181
USPC 434/301

(57) ABSTRACT

A circuit modeling simulator is provided as an educational tool substantially duplicating and expanding a hardware-based breadboard educational tool. To do so, the system and method provides a circuit modeling simulator that allows a user to create and test a simulated electronic circuit, and includes a library of schematic components, displayed on the side of a screen that allows a user to drag and drop the components anywhere on the project screen, displayed at a center of the screen. The user can place multiple occurrences of each type of device, and each component includes a drop down window that allows the user to select the particular model and value of the component. The user is also provided with simulated testing devices or meters that display the appropriate values based on the circuit parameter behaviors.

### BACKGROUND OF THE INVENTION

1. Field of the Invention

The present invention relates to an educational tool substantially duplicating and expanding a hardware-based breadboard educational tool. To do so, the system and method provides a circuit modeling simulator that allows a user to create and test a simulated electronic circuit, and includes a library of schematic components, displayed on a screen, that allows a user to drag and drop the components anywhere on the project screen to create a simulated electronic circuit and thereafter, simulate activation of the circuit and obtain resulting test data.

2. Description of the Related Art

As the need for a skilled, technical work force has grown, so has the need for educational tools to target and train such a work force. In the past, such educational tools required the participation of educators at locations that were convenient to the largest concentrations of students, and the provision of materials and laboratories that could be modified over time as technologies and associated skill bases developed. For some technical skills, such tools can be costly to provide and revise in a uniform and effective manner. For example, electrical and electronic technical skills training often requires hands-on educational tools including circuit elements and measurement tools at each location where students are to study. Such tools can be costly and in limited supply, and can be costly to revise as technologies change, and educational focus changed in unison.

One educational tool that is familiar to those in the electrical and electronic service industry is the breadboard. A breadboard is tool for the prototyping of electrical circuits and systems, thereby allowing a student to easily create, modify and then study various circuit design results. A typical solderless breadboard or plugboard consists of a perforated block of plastic with numerous tie points or contact points between selected perforations. The spacing between the perforations is configured to allow the insertion of integrated circuits (ICs) in dual in-line packages (DIPs), interconnecting wires, and the leads of discrete components such as capacitors, resistors, and inductors. In some designs, commonly used elements and incremental values of capacitors, resistors, and inductors can be incorporated within the breadboard. As no solder connections are needed, each element can be added and removed from the breadboard such that the breadboard can be reused. Further, in more advanced designs, a power supply with multiple taps, frequency generator, antennae and other commonly required features, can be provided with the breadboard to aid in circuit operation and testing.

However, there is a high cost associated with providing each student at each location with a breadboard with the most advanced features. Further, such breadboards have a number of technical limitations associated with their very constructions, including large levels of stray capacitance, high levels of contact resistance, and an inability to handle surface mount technology devices. Also, such breadboards cannot be used for all circuit simulations due to voltage and current ratings, and are typically limited to operations at relatively low frequencies. Accordingly, there is a need to address one or more of the difficulties associated with the current technology.

One solution to avoid such costly educational equipment is the replacement of physical educational tools with computer-based study tools. U.S. Pat. No. 6,371,765 of Wall et al., the entire disclosure of which is incorporated herein by reference, describes the use of an interactive computer-based training (ICBT) tool. In Wall, the ICBT system is provided with a state-machine-based hardware simulator for emulating various hardware states associated with a piece of equipment on which the users are to receive interactive training, and is provided with a software simulator as a command inference engine coupled to the hardware simulator, wherein the software simulator allows the users to interactively interrogate the emulated piece of equipment for its software functionality. However, as noted in Wall, the existing ICBT solutions are not optimized for providing adequate levels of instruction in all situations, such as those providing instruction on complicated equipment.

In another solution to avoid costly educational equipment, U.S. Pat. No. 8,152,529 of Bardige et al., the entire disclosure of which is incorporated herein by reference, describes another computer-based educational system providing the user with a suite of graphic editing tools, allowing the design of graphical objects, such as symbols and text that can be displayed to a viewer using a computer terminal. The user has the ability to control parameters of the graphical objects, allowing the user to create simulations or models of subject matter, such as mathematical principles, in order to facilitate the educational process. The parameters of these graphical objects can be defined in terms of variables, and specifically, functions or expressions including those variables and then the values of the variables are controlled in real-time by the user.

Still another solution to avoid costly educational equipment is described by U.S. Pat. No. 8,140,302 of Brewton, the entire disclosure of which is incorporated herein by reference. In Brewton, another computer-based educational system is described including a computationally-based modeling environment in which, the modeling of a physical entity can include identifying a physical component of the physical entity such as in the case of a power line segment being modeled, wherein the physical component is defined by at least a structural physical parameter and at least one physical behavior. In Brewton, the physical component includes circuit elements such as (R1) (R2) (L1) (L2) and (C). These elements can be formed for modeling the physical component in the environment by providing at least one function-based structural variable to define the structural physical parameter, and at least one behavior to define the behavior of the model element.

However, in each case, these computer-based educational systems are not configured to replace a breadboard nor correct the deficiencies found in such breadboards, while sufficiently duplicating the breadboard to ease use and minimize training required for the user. Accordingly, a need remains for a system and method to replace costly educational equipment with computer-based educational tools that sufficiently duplicate the replaced educational equipment with which users are familiar, but provide extensively expanded functionality.

### SUMMARY OF EMBODIMENTS OF THE PRESENT INVENTION

The above and other difficulties associated with the current technology are substantially solved by providing the following embodiments of the present invention. Accordingly, it is an object of embodiments of the present invention to provide a circuit modeling simulator that allows a user to create and test a simulated electronic circuit, and includes a library of schematic components, displayed on a screen, that allows a user to drag and drop or otherwise move and place the components anywhere on the project screen.

Accordingly, it is an object of embodiments of the present invention to provide a machine (i.e., computer or system), to allow a user to create and test a simulated electronic circuit.

To do so, it is an object of embodiments of the present invention to provide a machine (i.e., computer or system), to provide a project screen upon a display and a library of schematic components, that can be accessed and displayed on the screen or display, such that a user input can be used to drag and drop or otherwise move and place the components of the library anywhere on the project screen.

It is another object of embodiments of the present invention to provide a machine (i.e., computer or system), to provide a dropdown window for each component that allows the user to select a particular model, value and other attributes of the component.

It is another object of embodiments of the present invention to provide a machine (i.e., computer or system), to provide a library of simulated power supplies and operating conditions (i.e., voltage, current, frequency, noise, etc.) that can be applied to the simulated electronic circuit.

It is another object of embodiments of the present invention to provide a machine (i.e., computer or system), to provide a library of simulated testing devices or meters (i.e., voltage, current, etc.) that display detected attributes based on the circuit behaviors.

In accordance with the above and other objects, exemplary embodiments of the present invention provide a machine such as a computer or system, to provide a circuit modeling simulator as an educational tool by substantially duplicating and expanding a hardware-based breadboard educational tool. To do so, the system and method provides a computer or system, that allows a user to create and test a simulated electronic circuit, and includes a library of schematic components, displayed on a screen, that allows a user to drag and drop or otherwise move and place the components anywhere on a project screen. The user can place and schematically connect multiple occurrences of each type of component, and each component can include a dropdown window that allows the user to select a particular model, value and other attributes of the component. The user is also provided with simulated power supplies and operating conditions (i.e., voltage, current, frequency, noise, etc.) that can be applied to the simulated electronic circuit. The user is still further provided with simulated testing devices or meters (i.e., voltage, current, etc.) that display detected attributes based on the circuit behaviors.

### BRIEF DESCRIPTION OF THE DRAWINGS

The above and other objects, features and advantages of embodiments of the present invention will become more apparent from the following description taken in conjunction with the accompanying drawings, in which:

FIG. 1 is system level block diagram of an exemplary embodiment of the present invention;

FIG. 2 is block diagram of a processor of the system of FIG. 1 according to an exemplary embodiment of the present invention;

FIG. 3 is a flow chart of a method illustrating steps in a process to create and test a simulated electronic circuit according to an exemplary embodiment of the present invention; and

FIG. 4 is a set of screen views (a) to (p) provided through an operation of the system according to an exemplary embodiment of the present invention.

Throughout the drawings, like reference numerals will be understood to refer to like parts, components and structures.

### DETAILED DESCRIPTION OF EXEMPLARY EMBODIMENTS

Certain exemplary embodiments of the present invention will now be described in greater detail with reference to the accompanying drawings. The matters defined in the description such as detailed constructions and elements are nothing but the ones provided to assist in a comprehensive understanding of the invention. Accordingly, those of ordinary skill in the art will recognize that various changes and modifications of the embodiments described herein can be made without departing from the scope and spirit of the invention. Also, well-known functions or constructions are omitted for clarity and conciseness.

### DEFINITIONS

Asset Files: All files utilized in the development of the project in a non-flattened format. These include but are not limited to psd, ai, eps, fla, png, raw video/audio, metadata, etc.

DMM: Digital Multimeter.

ETS: Electrical Theory Simulator.

Metadata: Context-independent metadata addresses digital assets, content objects, etc. Context-dependent metadata addresses particular context organization.

NetConference: Internet conference meeting software such as GoToMeeting allowing all users to view SCORM compliant set of module designs.

Package Interchange File (PIF): A file that contains all files needed to deliver the content package via a learning management system (LMS).

RAID: The primary purpose of the SCORM compliancy: Reusable, Accessible, Interoperable, and Durable.

SCORM: Sharable Content Object Reference Model—Standard that uses metadata to specify the structure of learning objects and a content aggregation scheme; packaged objects with XML language format.

UI: User Interface screen (i.e. Screen layout, color, manual of style, etc.).

UX: User Wireframe and functionality design of UI.

Wireframe: A diagram of the webpages the end users will view to migrate throughout the training and to complete tasks.

XML manifest file: A manifest of profile management for the XML content.

### EXEMPLARY EMBODIMENTS

In accordance with an exemplary embodiment of the present invention, a computer or system, hereinafter referred to as an Electrical Theory Simulator (ETS), is provided and configured to allow a user to create and test a simulated electronic circuit, and includes a library of schematic components, that can be accessed and displayed on a screen or display, preferably at a side or edge of the screen or display. A user input is provided to allow the user to drag and drop or otherwise move and place the components of the library anywhere on a project screen, preferably displayed at a center of the screen. The user can place and schematically connect multiple occurrences of each type of component, and each component can include a dropdown window that allows the user to select a particular model, value and other attributes of the component. The user is also provided with a library of simulated power supplies and operating conditions (i.e., voltage, current, frequency, noise, etc.) that can be applied to the simulated electronic circuit. The user is still further provided with a library of simulated testing devices or meters (i.e., voltage, current, etc.) that display detected attributes based on the circuit behaviors. In doing so, the Electrical Theory Simulator (ETS) is provided to function as a circuit modeling simulator to provide a user with an educational tool substantially duplicating and expanding a hardware-based breadboard educational tool.

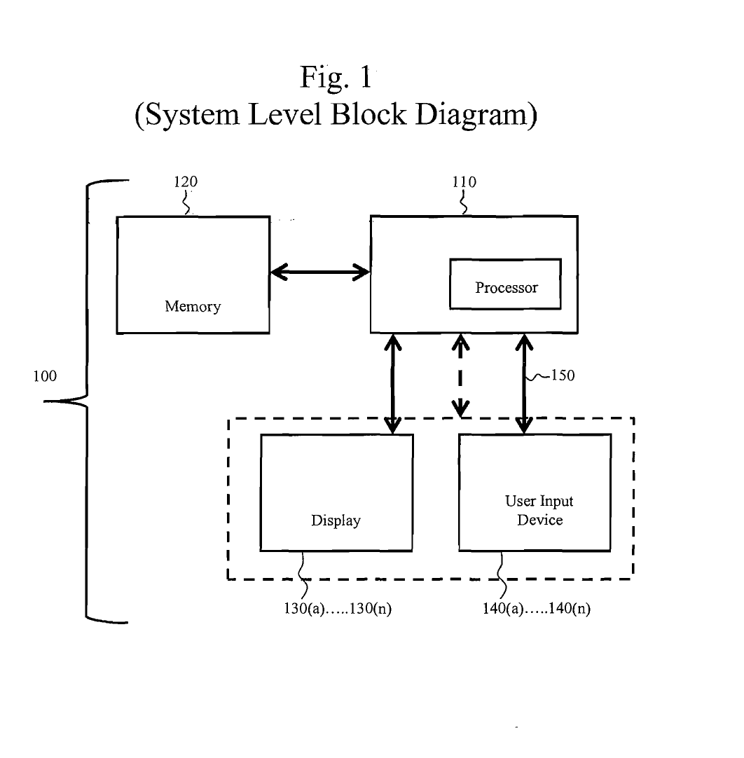

FIG. 1 is system level block diagram of an exemplary embodiment of the present invention, illustrating an Electrical Theory Simulator (ETS). The ETS is user accessible via a Learning Management System (LMS). A Learning Management System (LMS) is a software application for the administration, documentation, tracking, reporting and delivery of online education courses or training programs. An LMS is typically configured to centralize and automate administration, use self-service and self-guided services, assemble and deliver learning content rapidly, consolidate training initiatives on a scalable web-based platform, support portability and standards, personalize content and enable knowledge reuse, and deliver online training and webinars.

As shown in FIG. 1, the ETS 100 comprises a processor 110, a memory 120, a display 130 and a user input 140. The features of FIG. 1 are shown separately, but are not limited thereto. In other exemplary embodiments of the present invention, one or more of the features of FIG. 1 can be combined. Further, in yet other exemplary embodiments of the present invention, one or more of the features of FIG. 1 can be provided in greater numbers. For example, a single central processor 110 can be provided for multiple user inputs 140(a)-140(n), and/or multiple displays 130(a)-130(n). In this case, the central processor 110 can be centrally provided for multiple user inputs 140(n), and a plurality of user inputs 140(n) can be coupled with the centralized processor 110 such that a singular processor and memory can serve a plurality of users. Each of the users 140(n) can access the central processor of the system via the Learning Management System (LMS) and execute instructions of the Electrical Theory Simulator on the one central processor 110.

Further, such a centralized processor and memory can serve a plurality of remote or dispersed users. In this case, updates to the system can be simplified in that a single central processor and memory require maintenance and updates, which is implemented to a wide range of users via the multiple user inputs 140(a)-140(n), and/or multiple displays 130(a)-130(n). The plurality of displays 130(n) can be provided to correspond to the plurality of user input devices 140(n).

In such a network of users, the simulated circuit of each user can be saved to a memory of the user 140(n) or to a memory 120 of the central processor 110. Once stored, the data can then be shared via email or any other file sharing method between users 140(n).

Returning to FIG. 1, the system 100 comprises the one or more displays 130 and user inputs 140 in wired or wireless communication with the central processor 110 via communication link 150. The communication link 150 can be a wired or wireless, LAN, WLAN, ISDN, X.25, DSL, and ATM type network or combination thereof, for example and others as specified under the IEEE 802 wireless standards, including but not limited to 802.11 (WiFi, WLAN), 802.15 (WPAN, Bluetooth, ZigBee) and 802.16 (WMAN). The processor 110 can comprise one or more machines such as computers or similar systems, to allow a user to create and test a simulated electronic circuit, and includes a library of schematic components, simulated power supplies and operating conditions and simulated testing devices or meters in the manner described in greater detail below.

The processor 110 can comprise a typical combination of hardware and software including system memory, operating system, application programs, graphical user interface (GUI), processor, and storage. Additional memory 120 can be provided as RAM, ROM, or similar memory, which can contain electronic information such as the library of schematic components, simulated power supplies and operating conditions and simulated testing devices or meters. The operating system of the processor 110 is suitable for use with the functionality described herein.

As noted above, the multiple user inputs 140(a)-140(n), and/or multiple displays 130(a)-130(n) can be provided at remote locations, and linked with the processor 110 provided at a central location, such as a technical education firm, in the business of providing technical education programs, materials and support. Where remotely provided, the multiple user inputs 140(a)-140(n), and/or multiple displays 130(a)-130(n) can be configured to receive processing results from the processor 110 and allow a user to create and test a simulated electronic circuit. Where the user inputs and displays are combined, the combination can comprise a wired or wireless computer, iPhone™, iPad™, graphics tablet or other user terminal with display abilities.

As noted above, the Electrical Theory Simulator (ETS) embodied on the processor 110, is a computer-graphics, circuit modeling simulator that allows a user to create and test a simulated electronic circuit. Specifically, the ETS allows a user to use the user input 140 to access and execute hardware and software including system memory, operating system, application programs, graphical user interface (GUI), processor, and storage of the processor 110 via the LMS create a project screen, displayed preferably at a center of the screen of the display 130, and direct the processor 110 to display one or more libraries of schematic components, displayed preferably on the side of the project screen. The user can also direct the processor 110 to allow the user to drag and drop or otherwise move and place components of the libraries anywhere on the project screen, to thereby create and test a simulated electronic circuit.

For example, the user input 140 can comprise a keyboard or keypad, stylus, or similar input tool. Where the user input 140 and display 130 are combined, the display can be configured as a touchscreen and serve as the user input. The user can execute a command using the user input to execute hardware and software of the processor 110 to create a project screen on the display 130, preferably as a work space bounded by a border and having a background color selectable by the user.

One or more project screens can be created and the user can overlay each, or shift between each. Once the project screen is established, the user can execute a command using the user input to execute hardware and software of the processor 110 to retrieve and display one or more libraries of the memory 120 on the display 130. As noted above, the library of schematic components is displayed preferably on the side of the screen or display, preferably as a box bounded by a border and having a background color selectable by the user, and distinguishable from the work space.

The user can then execute commands using the user input to execute hardware and software of the processor 110 to drag and drop or otherwise move and place the components of the library anywhere on the project screen, displayed preferably at a center of the screen. The user can place multiple occurrences of each type of component, and provide schematic connections between components in a number of manners. For example, the user can drag and drop connections, or simply click one node or point in the circuit, and then another, to create a connection between each. The connection is preferably illustrated as a line, but is not limited thereto. The user has the ability to select a color of the connections (i.e., red, black, blue, green, white, etc.), and has the ability to relocate a connection or erase it completely without affecting other connectivity. Accordingly, the embodiments of the present invention allow the user to quickly and easily shape the circuit paths and provide an orderly circuit layout.

The ETS also allows the user to select a particular model and value of the component. For example, the user can execute a command using the user input to execute hardware and software of the processor 110 to retrieve and display one or more dropdown windows of each component or groups of components that allows the user to select a particular model and value of the component. The dropdown windows of each component or groups of components is displayed preferably at or near the component, preferably as a box bounded by a border and having a background color selectable by the user, and distinguishable from the work space. The dropdown window can provide a library of a specific component models and values of the component for selection by the user. For example, for a resistor selection, these can include construction types including carbon, film, composition, wirewound and so forth, tolerance and resistance value. In yet another embodiment of the present invention, even the electronic color code can be shown once the resistor is selected. Similar dropdown windows can be provided for other circuit elements including capacitors, inductors, diodes, transformers, sources, grounds, gates, switches and so forth. In the case of groups of components, such as an RC filter, the dropdown window of the group of components is displayed preferably at or near the component, again preferably as a box bounded by a border and having a background color selectable by the user, and distinguishable from the work space. The dropdown window can provide a library of a specific component models and values of the group of components for selection by the user.

The user is also provided with a library of simulated power supplies and operating conditions (i.e., voltage, current, frequency, noise, etc.) that can be applied to the simulated electronic circuit. The user can execute commands using the user input to execute hardware and software of the processor 110 to again drag and drop or otherwise move and place the simulated power supplies and create the operating conditions of the library anywhere on the project screen, displayed preferably at a center of the screen. A dropdown window of the simulated power supplies and operating conditions can be displayed preferably at or near the component, again preferably as a box bounded by a border and having a background color selectable by the user, and distinguishable from the work space. The dropdown window can provide a library of a specific power supply models and values for selection by the user, and can provide a library of operating conditions.

The user is still further provided with a library of simulated testing devices or meters (i.e., voltage, current, etc.) that can be applied to the simulated electronic circuit and display detected values based on the circuit behaviors. The user can execute commands using the user input to execute hardware and software of the processor 110 to select a testing device or meter and drag and drop or otherwise move and place test leads of the simulated testing devices or meters anywhere on the project screen, displayed preferably at a center of the screen. A dropdown window of the simulated testing devices or meters can be displayed preferably at or near the component, again preferably as a box bounded by a border and having a background color selectable by the user, and distinguishable from the work space. The dropdown window can provide a library of a specific testing device or meter models and values for selection by the user.

For example, the ETS provides the user with simulated inline current and parallel voltage meters, and the library of elements provides the user with various configurations, ranges, and settings applicable for these meters, including DMMs (Digital Multi-Meter) which can be connected via simulated test leads. The ETS also provides for oscilloscope measurements, using for example, a 20 Mhz 2-channel oscilloscope that can also be connected via simulated test leads. The ETS still also provides tools for signal generation, using for example, a function generator that can be connected via simulated leads. Indication of operating settings of these devices such as switches, ranges, waveforms, etc. can be displayed on these simulated meters and can be set by the user. The ETS can also perform a pre-energized check on the created simulated circuit before runtime. Such a check can include safety checks, open-circuit at the source checks, and additional checks and operations as desired. In these and other exemplary embodiments of the present invention, the user can create unique tools, meters and other equipment for use with the simulated circuit.

At any stage, the user can save the material of the project screen to the memory 120 or a memory of the user. In an exemplary embodiment, the saved material can be titled and protected in some manner, such as through the use of a password or key. Likewise, the material can be shared with other users. As noted above, in such a network of users, the simulated circuit of each user can be provided to the single user only, or can be shared between the plurality of users 140(n).

In doing so, the ETS is provided to function as a circuit modeling simulator to provide a user with an educational tool substantially duplicating and expanding a hardware-based breadboard educational tool. Once the simulated circuit is constructed and the simulated power supplies and operating conditions are applied, the ETS performs all necessary mathematical calculations utilizing the models and values of each component as entered by the user, or as valued by default where no user value is entered, to produce a behavioral model of the circuit at every node location. The user is able to measure various electrical quantities (i.e., volt, current, resistance, etc.) at nodes in the circuit using the simulated testing devices or meters. During testing, the ETS allows real-time changes to the simulated circuit, power supplies and operating conditions, and testing devices or meters, which measure various electrical quantities indicating these changes in real-time.

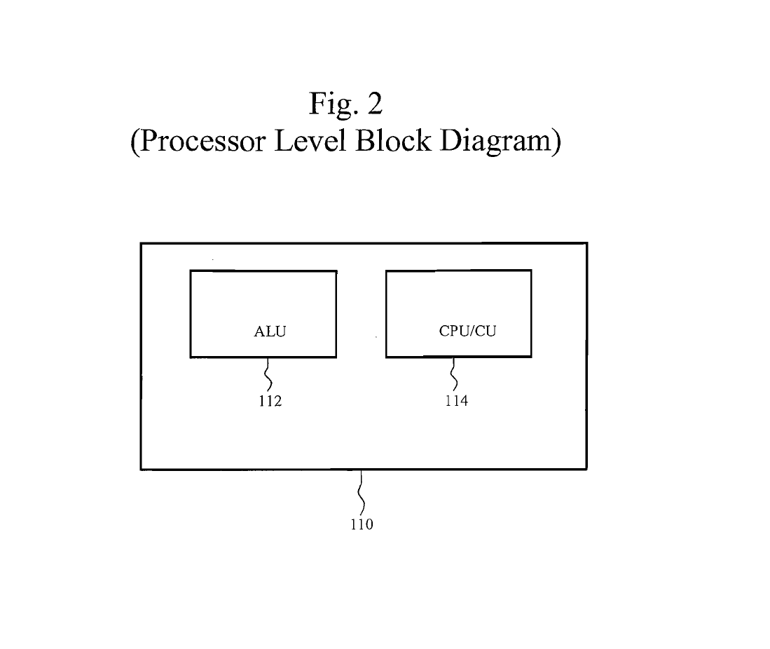

To perform such operations, the operating system of the processor 110 of FIG. 2, can comprise software and related tools, procedures, forms and data used to implement the processes and which can be accessed by a user via the LMS. As noted above, LMS is a software application for the administration, documentation, tracking, reporting and delivery of online education courses or training programs.

The computer code and/or software to perform such operations can be obtained from vendors such as 3DInternet of Alberta, Canada and Los Angeles, Calif., and can be embodied upon a computer-readable medium of the processor of FIG. 1. FIG. 2 is block diagram of a processor 110 according to an exemplary embodiment of the present invention. The processor 110 can comprise a computer-readable medium holding computer-executable instructions that when executed cause at least one computing device to perform all necessary mathematical calculations utilizing the models and values of each component as entered by the user, or as valued by default where no user value is entered, to produce a behavioral model of the circuit at every node location.

The processor 110 can comprise one or more of a central processing unit (CPU), microprocessor, graphics processing unit (GPU/VPU), physics processing unit (PPU), digital signal processor, network processor, front end processor, data processor, word processor and audio processor. In an exemplary embodiment, the processor 110 comprises an arithmetic logic unit (ALU) 112 and a control unit (CU) 114. As known to those skilled in the art, the ALU performs arithmetic and logical operations of the processor 110, and the CU extracts, decodes and executes instructions, such as those stored in the memory 120.

In an exemplary embodiment, the ETS is configured to function within a Modular Object-Oriented Dynamic Learning Environment (Moodie) 2.0 LMS environment as Sharable Content Objects (SCOs). Moodie is a free source e-learning software platform. In yet other embodiments of the present invention, the user can access the materials outside of the LMS setting. The Sharable Content Object Reference Model (SCORM) SCOs fall within the requirements of sections SCORM Packaging and the RAID industry guidelines. In doing so, the preferred ETS is a 100% graphical simulation program that models the behavior of an analog electronic circuit in regards to, but not limited to, DC, AC, and Semiconductor Theory.

Further features of the ETS can include animations developed using software that publishes files, including Adobe FLASH “.swf” files or Unity. Rapid eLearning software tools can include Adobe Captivate, and browser plug-in software can include Adobe FLASH (.swf), but in each case, embodiments are not limited thereto. In an exemplary embodiment, the ETS is configured to run within the Moodie 2.0 LMS in such a manner that browser plug-ins, other than Adobe FLASH, are not required by the user.

Though the primary function and operation of the ETS is a simulator, other elements of instructional design can be provided. Instructional design is preferably not limited to components, therefore, the user is allowed to augment the ETS with creative ideas in circuit theory, etc., using graphics, animations, and text primarily for content references and transitions, to convey instructional points, review, and assessment such as self-checks.

The user can also configure a lab circuit utilizing a set of analog devices, and the ETS will function as a circuit modeling simulator with nominal circuit parameter behaviors such as a physical Lab Trainer Simulator. In an exemplary embodiment, before energizing the circuit, the user can perform a variety of safety checks to ensure the circuit is not destructive. This can reinforce the importance of safety checks, which should always be implemented before energizing a circuit in a real world setting.

The user of the ETS preferably works with an associated textbook and Lab exercises as part of the resource materials for the comprehensive use of ETS for maximum benefit to the user. The labs, such as those of the NJATC DC, AC, and Semiconductor courses, are maintained to be fully functional within the ETS, and a list of proposed labs is listed at the end of this specification. If applicable, graphics and/or animations can be associated with the listed labs or combinations thereof.

As noted above, the processor 110 can comprise graphical user interface (GUI) that is preferably constructed in a high-level illustrated approach. The user is able to connect the components graphically, and not simply in a text command format or tagged-based code approach. Once created, the component area or project screen of the ETS is completely visible on one screen, and is provided with a quick and efficient variable zoom feature that allows the user to examine all the components of a large circuit in detail. In an exemplary embodiment, the ETS can provide two views, including a circuit schematic view and a field view. The user is allowed to select components, place them on the project screen, and place connections between the components in both views. Both views also track each other automatically, so that changes are made simultaneously between views of respective projects and switching between the two views yields the same circuit.

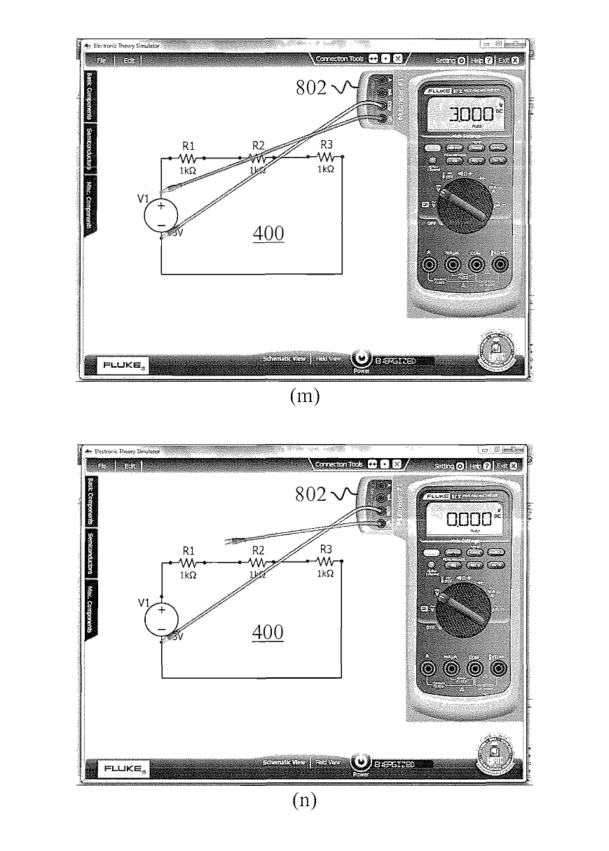

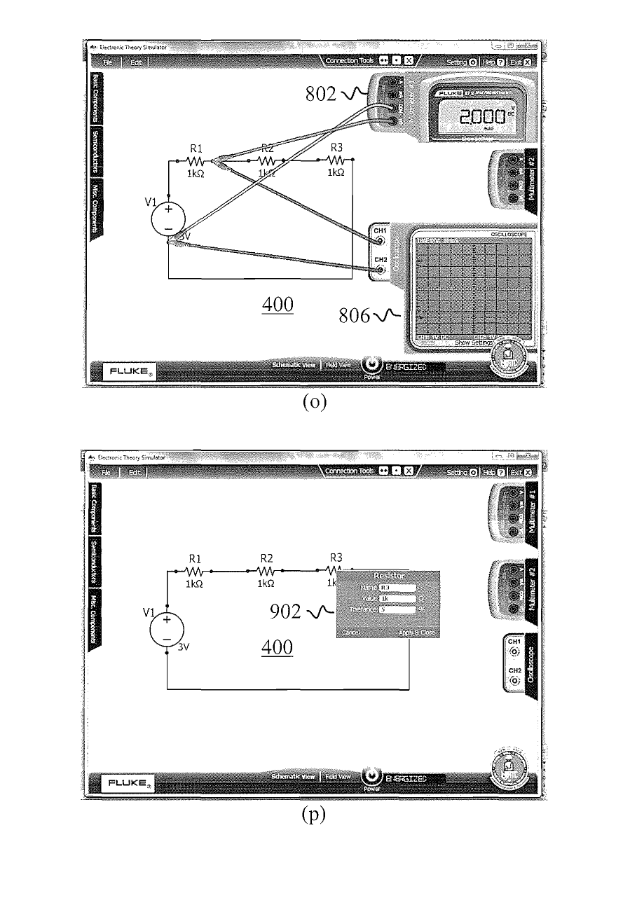

FIG. 4 is a set of screen views (a) to (p) of the display 130 provided through an operation of the system according to an exemplary embodiment of the present invention. Specifically, views (a) to (p) are example of field views of the ETS display that demonstrate the library of illustrated components on sides of the exemplary project screen, and which allows the user to drag and drop or otherwise place elements anywhere on the project screen, and energize and test the project in a manner substantially duplicating and expanding a hardware-based breadboard educational tool.

As noted above, the ETS can provide at least two views for the benefit of the user, including a circuit schematic view illustrated in view (i) and a field view illustrated in view (j). A circuit schematic view illustrates what a user may observe from a wiring diagram or text, and a field view illustrates what a user may observer from an actual circuit found in a device (to the extent possible). The circuit schematic and field views share all functions and operations and, therefore, track each other automatically, so that projects created, energized and tested in one view, are simultaneously created, energized and tested in the other view. Switching between the two views yields the same circuit but in a circuit schematic format in one view, and a field format in another view. The components, both as shown in the libraries and as placed in the circuit, further share such automatic tracking between the circuit schematic and field views. For example, elements of the basic components library shown in view (i) are presented in a circuit schematic format, and are presented in a field format in view (j). The user can easily switch between views at any time using tabs as described in greater detail below.

A space for the project is provided at a center of the display, surrounded by a number of useful and easily reached tool bars. The user is allowed to select components from the tool bars, place them on the project screen, place connections between the components to create a simulated circuit, view the circuit in both a schematic view and a filed view, energize the components and take a number of measurements at desired locations.

In an exemplary embodiment of the present invention, the screen display 400 comprises a top-side library tool bar 500, a bottom-side library tool bar 600, a left-side library tool bar 700, and a right-side library tool bar 800, but exemplary embodiments are not limited thereto. In yet other exemplary embodiments, one or more tool bars can be omitted, combined, or presented on the screen display in another manner without deviating from the scope of the present invention.

The exemplary top-side library tool bar 500 is tabbed to show tabs for selecting or indicating file management 502, edits 504, connection tools 506, settings 510, help 512 and exit 514. The exemplary bottom-side library tool bar 600 is tabbed to show tabs for selecting or indicating schematic view 602, field view 604, test circuit power 606 and test circuit power status 608. The exemplary left-side library tool bar 700 is tabbed to show tabs for selecting or indicating basic components 702, semiconductors 704 and miscellaneous components 706. The exemplary right-side library tool bar 800 is tabbed to show tabs for selecting or indicating multimeters 802, multimeters 804 and oscilloscopes 806.

Referring to FIG. 4, view (a), upon execution of the ETS upon the processor 110, which can comprise graphical user interface (GUI), the graphical display of view (a) is provided upon display 130. The user can then begin a new project, or access and load a previously stored project. The creation of a new project is easily facilitated by the tool bars surrounding the project screen. The tabs of tool bars 500, 600, 700 and 800 are configured to respond to mouse or pointer placement and switching. For example, a mouse can be used to place a pointer to select a tab, and clicking a mouse button can be used to activate the function of the tab as described in greater detail below. As shown in views (b)-(h), one function of the tab is to expand and show a library of components identified by the tab label. Further mouse and/or pointer movement can be used to select and place components, connections and test leads. Further, mouse and/or pointer movement can be used to select views, apply test power to the simulated circuit, and take measurement from the simulated circuit.

Referring to views (b)-(d), features of the tool bar 700 are illustrated. The tool bar 700 and associated libraries of components are displayed on the side of the screen or display, preferably as a box or tab bounded by a border and having a background color selectable by the user, and distinguishable from the work space. The user can execute commands using the user input, such as a mouse and pointer, to execute hardware and software of the processor 110 to activate a function of the tabs 702, 704 and 706 to expand and show a library of components identified by the tab label, and drag and drop or otherwise move and place the components of the library anywhere on the project screen, displayed at a center of the screen. In one exemplary embodiment, the mouse can be used to drag and drop components from the library to the project screen. Simple clicks of a mouse switch while a pointer is positioned over a selected component will automatically place one selected component on the project screen, and subsequent clicks of the mouse switch will place additional selected components on the project screen in a cascading manner. Each component can be moved about the screen using the mouse and pointer. Further, as described in greater detail below, a click of another mouse switch while a pointer is positioned over a selected component will display a drop down box 902 for the display and setting of the component label (name), value and tolerance of the selected component as shown in view (p). An example of a simple project screen in circuit schematic format is shown in view (i), and when field format view is selected, the same circuit is shown in view (j).

In the exemplary embodiment shown, tab 702 is configured to expand upon selection and show a library of basic components including, but not limited to, a DC voltage supply, an AC voltage supply, resistor, capacitor and inductor, as shown in view (b). Tab 704 is configured to expand upon selection and show a library of semiconductor components including, but not limited to, a diode, LED, BJT (NPN) and BJT (PNP), as shown in view (c). Tab 706 is configured to expand upon selection and show a library of miscellaneous components including, but not limited to, a ground, as shown in view (d). In the exemplary embodiment, selecting opposite tabs, such as those of tool bar 800, will cause the tabs of tool bar 700 to collapse as shown in views (b) and (e).

The drop down box for the display and setting of the component label (name), value and tolerance of the selected component as shown in view (p) is preferably displayed at or near the component, preferably as a box bounded by a border and having a background color selectable by the user, and distinguishable from the work space. The model, value and other characteristics of the component can then be textually displayed, and the user can simply type in the component label (name), value and tolerance of the selected component in the provided spaces. Where no value is assigned by the user, the ETS is configured to alert the user as to the missing value or assign a default value to the component. Such default values can be set by the user.

The user is also provided with the ability to provide connections between placed components on the project screen using the connection function of tab 506. For example, the user can drag and drop connections, or simply click one node or point in the circuit, and then another, to create a connection line between each. Once connected, the user can move components of the circuit and the connections remain, accommodating the component movement by stretching and contracting. The user has the ability to select a color of the connections (i.e., red, black, blue, green, white, etc.), and has the ability to relocate a connection or erase it completely without affecting other connectivity.

Referring to views (e)-(h), features of the tool bar 800 are illustrated. The tool bar 800 and associated libraries of testing devices are displayed on the side of the screen or display. The user is provided with a testing device or meter tab illustration or icon 802, 804 and 806, wherein the user can input a request to search and select a model and value of the testing device or meter from a library of simulated testing devices or meters (i.e., voltage, current, etc.) that can be applied to the simulated electronic circuit and display detected values based on the circuit behaviors. As shown in views (e)-(h) the selected testing device or meter can be shown at a location on the project screen and the user can execute commands using the user input to execute hardware and software of the processor 110 to again drag and drop or otherwise move and place one or more of the simulated leads of the testing devices or meters of the library on the project screen, as shown by way of example in views (m)-(o). As shown in views (m) and (n), a dropdown window of the simulated testing devices or meters, in this case, Multimeter 802 can be displayed in a shape of an actual device as shown in views (m) and (n), known to the user, and further, settings and values of the simulated testing devices or meters can be made using the shape of the actual device. That is, the user can be permitted to turn simulated dials or press simulated buttons of the image of the simulated testing devices or meters. Default settings of the simulated testing devices or meters are based upon the simulated circuit. That is, where the simulated circuit has a DC power supply, the simulated testing devices or meters will appear first in a DC power measurement mode.

As noted above, the user can drag and drop or otherwise move and place one or more of the simulated leads of the testing devices or meters of the library on the project screen, as shown by way of example in views (m)-(o). For example, the user can drag and drop test lead connections, or simply click one node or point in the circuit, to create a test lead connection. Once connected, the user can move components of the circuit and the test lead connections remain, accommodating the component movement by stretching and contracting.

As noted above, the user can place multiple occurrences of each type of device. However, the ETS can be configured to limit the number, or set a minimum number of components in an exemplary simulated electronic circuit.

Once the simulated circuit is completed, the user can active or energize the simulated circuit using tab or button 606 of the tool bar 600. In doing so, the simulated power supplies as placed and connected in the simulated circuit by the user, apply the labeled power as connected to the simulated circuit. Prior to activation, the ETS is configured to automatically perform a safety test of the simulated electronic circuit. A first safety operation can be performed for the verification of a non-destructive circuit utilizing the DMM. The DMM setting can be set to test resistance. The test can check for both unsafe resistance between non-grounded conductors, and also between each conductor and ground. The test can also check for an open circuit at the source, and any other additional operations that may be desirable.

In the energized mode, the meters (i.e., voltage, current, etc.) display the appropriate values in real time based on the circuit parameter behaviors. For example, as shown in view (m), the meter 802 shows a measured value of 3 VDC. As the test lead is being moved in view (n), the meter 802 shows a measured value of 0 VDC. Once the test lead is moved in view (o), the meter 802 shows a measured value of 2 VDC, correctly showing the voltage drop. Multiple meters can be connected as shown in view (o).

As noted above, the ETS can provide two views, including the circuit schematic in view (i), and the field in view (j). The user is allowed to select components, place them on the project screen, place connections between the components, apply test meters and observe values in both views. Both views track each other automatically, so that switching between the two views yields the same circuit. The field view allows the user to become familiar with the image of the components used in the simulated electronic circuit. Also, as the field view reflects the image of the components, image factors such as color bands in the case of resistors, and other colors such as in the case of orange drop capacitors, can be displayed. The user can run, or energize and test, the simulator from either the Schematic View or the Field View. In run or energized mode, the meters (i.e., voltage, current, etc.) display the appropriate values based on the circuit parameter behaviors.

An example of components is listed at the end of this specification, but is not limited thereto. The component libraries only need to illustrate one of each device, since the user can drag and drop multiple instances of the same device onto the screen. In an exemplary embodiment, default values for the tolerance of components (i.e., resistors, etc.) can be set at 0% (of nominal value). Parameters of devices (i.e., BETA, internal resistance, etc.) can be configured to match the device specification of the components used in current labs.

As noted above, the user can review each component's specification from the library in both circuit views. In a limited exemplary embodiment, the user is not permitted to change the component's specifications other than those presented in the drop-down window, such as resistance values of a resistor. For example, the junction resistance of a diode, the BETA of a transistor and the internal resistance of a JFET can be listed, but not editable by the user. In other exemplary embodiments, such values can be editable by one or more users. In yet other exemplary embodiments of the present invention, the user can create and define components, including setting defined values, names for each component, as well as other customizations, identifications and operating parameters.

The component libraries preferably illustrate one of each device, but account for various models of components such as those in the library list. For example, the component libraries can separately show an NPN transistor with a BETA of 100, and an additional NPN transistor with a BETA of 200. This would require two separate transistors in the library. Further, each component is settable to values, such as the exemplary values listed at the end of this specification, utilizing the dropdown menu to set the value of each particular component (i.e., resistors with a dropdown menu allowing for 1K, 2.2K, 3.3.K, 4.7K, 10K, 15K, 22K, 33K, 56K, 100K, 470K, 1M, and 4,7M values). Current and voltage controlled devices (i.e., transistors, JFETS, MOSFETS, SCRs, etc.) are modeled to match the components utilized in the conventional labs. In addition to the DMM, voltage and current component meters are available and connectable in the circuit. In an exemplary embodiment, the measuring meters require setup, including the selection of voltage, current, resistance, etc., in both schematic and field views. The meters are preferably shown with digital displays, but are not limited thereto. Further, each component placed on the project screen is preferably automatically labeled in both schematic and field views. For example, resistors are labeled R1, R2, . . . ; switches are labeled SW-1, SW-2, . . . ; diodes are labeled D1, D2, . . . ; Zener diodes are labeled Zener-1, Zener-2, . . . ; lamps are labeled Lamp-1, Lamp-2, . . . ; capacitors are labeled C1, C2, . . . ; transistors are labeled NPN-1, NPN-2, . . . PNP-1, PNP-2, . . . ; voltage sources are labeled VS-1, VS-2, . . . ; current sources are labeled CS-1, CS-2, . . . , and so forth. However, the user is permitted to set labels as desired.

The ETS is a visual simulator that mimics a typical physical electronic trainer. The circuit is drawn using components from a library and connected in a circuit diagram approach between component nodes (i.e., schematic view), and also allows for complete connectivity in the field view also. The user has the ability to select the color of the connection lines (i.e., red, black, blue, green, white, etc.), and has the ability to relocate a connection or erase it completely without affecting other connectivity. The connectivity approach where the user clicks one node and then the other and the line is drawn, allows the user to have the ability to shape the path of the conductors to allow for an orderly circuit layout. Connection dots can be automatically configured to appear at nodes of two or more terminations.

The ETS is also configured to allow for simple inline current and parallel voltage meters in both schematic and field views. The library also includes various ranges of these meters. The user can place multiple occurrences of each type of device, where minimum and maximum values can be set. The ETS allows for DMMs (Digital Multi-Meters) connected via test leads in both schematic and field views. Indication of operating settings of these devices such as switches, ranges, waveforms, etc. are displayed on these meters and are set by the user, or are set to default values when the user fails to enter values. In an exemplary embodiment, the DMM includes an option to add a “cross the line” resistor selectable as 2.5, 5, 25, 50 ohms. The ETS also allows for a 20 Mhz 2-channel Oscilloscopes to be connected via test leads in both schematic and field views. Indication of operating settings of these devices such as switches, ranges, waveforms, etc. are displayed on these meters and are set by the user, or are set to default values when the user fails to enter values. The ETS also allows for a Function Generator to be connected via leads or parallel connection. Indication of operating settings of these devices such as switches, ranges, waveforms, etc. are displayed on these meters and are set by the user, or are set to default values when the user fails to enter values.

The ETS is also configured to perform a pre-energized check on the circuit before runtime, in both schematic and field views. This check preferably includes the following operations using, for example, a resistance meter. A first safety operation can be performed for the verification of a non-destructive circuit utilizing the DMM. The DMM setting can be set to test resistance. The test can check for both unsafe resistance between non-grounded conductors, and also between each conductor and ground. The test can also check for an open circuit at the source, and any other additional operations that may be included.

As noted above, the ETS is configured to function as a behavioral simulator modeling the nominal circuit parameters such as a physical Lab Trainer Simulator. The ETS is configured to perform all necessary mathematical calculations utilizing the parameters of each component to produce a behavioral model of the circuit at every node location. The user is therefore able to measure various electrical quantities (i.e., volt, current, resistance, etc.) at nodes in the circuit. The simulator is active during the energized mode to allow real time changes to sources and variable devices, and the measuring devices reflect these changes in real time.

However, any number of additional functions can be provided. For example, the ETS can include functions wherein the reconfiguration of components shall require de-energizing of the circuit. Measuring devices such as Oscilloscopes are configured to represent the live circuit at the appropriate frequency for the connected devices. For example, if a component output is clocked at 10 kHz, the Oscilloscope waveform reflects the time domain and frequency graphically.

Still further, the ETS allows for communicating duplex information to a user account. SCORM and additional information exchange (i.e., circuit presets, etc.) are included as a provision. For example, data can be transferred though other options, such as Adobe Captivate. These datum items include, but are not limited to, time spent in ETS, time and date stamps, etc., reporting of assessment activities (i.e., workable circuit, destructive circuit, etc.), bookmarking to remember the users last configuration of the ETS, and preset configurations. The status of each configured circuit (i.e., after energized) can include acceptable current draw at power source, pass and fail alerts, open circuit at power source alerts, and other parameters as needed.

A reset is also provided, which can serve to clear all leads, and a number of preset configurations or circuits are available for the user. These features include provisions for the user to reset the configuration to a state where no leads are connected and all power sources are set to “0”. This reset can also serve to clear all test instruments connected to the circuit. Further, the user device is configured to save preset configurations to files of the memory, and which can be accessible by an instructor to review the user's configurations.

Asset files of the ETS include but are not limited to photoshop files (psd) layered and not flattened, illustrator files (.ai or .eps), flash files (.fla), unity files, fireworks files (.png) layered, captivate files, all recorded video, including raw unedited files, and set of modules metadata. A SCORM content package is a self-contained ZIP file containing certain contents defined by the SCORM standard. SCORM content packages contain an XML manifest file that describes the package and its contents. The manifest file is a structured inventory of the content of the package. The name of the manifest file is always imsmanifest.xml and it must appear in the root of the content package. In an exemplary embodiment of the present invention, it contains SCORM version 2004 (4^{th} edition), but is not limited thereto, preamble section containing XML pointers, metadata section containing global information (i.e., Titles, etc.), organization section describing the ETS (module) sequencing, and resource section listing files used in the ETS (module). Content is generally compatible with SCORM if it can be delivered via a web browser, if it can be self-contained (i.e. packaged with all dependencies wholly in a ZIP file), if it does not depend on server-side scripting languages (such as JSP, ASP, and PHP), if it does not depend on external files or external URLs, it does not depend on downloadable components that must be installed by an administrator, and falls under the domain of RAID.

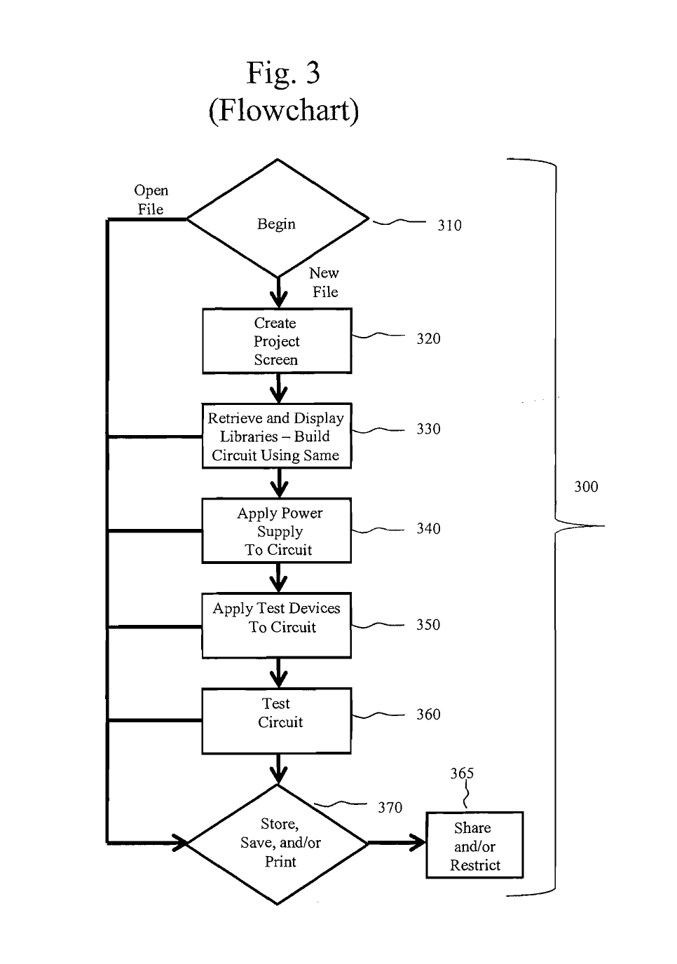

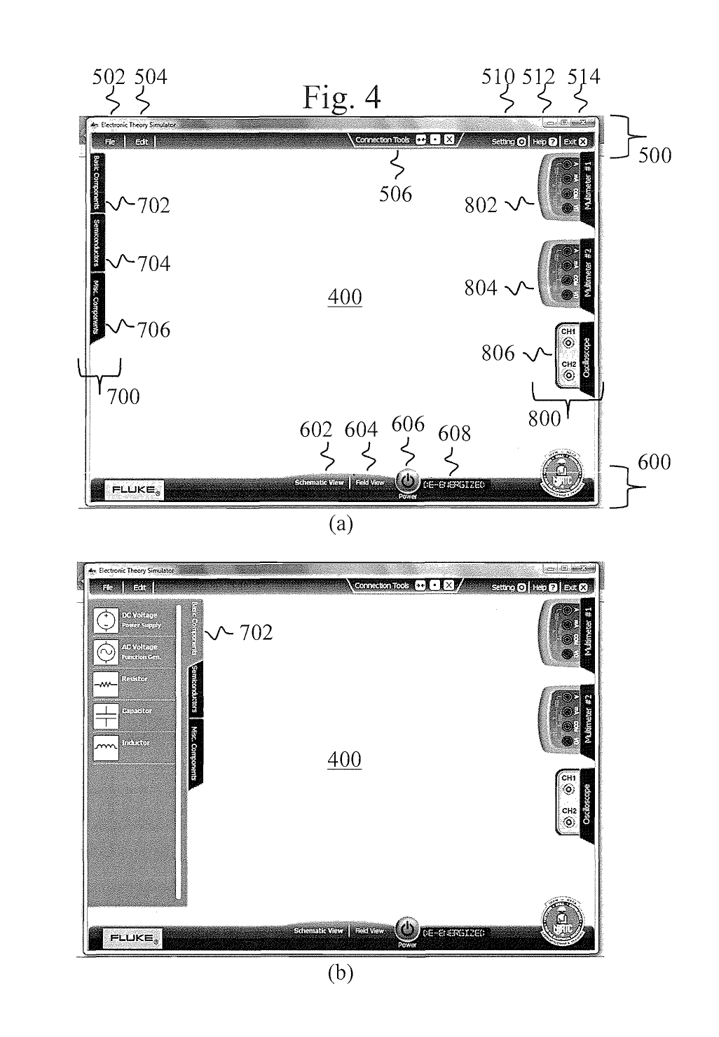

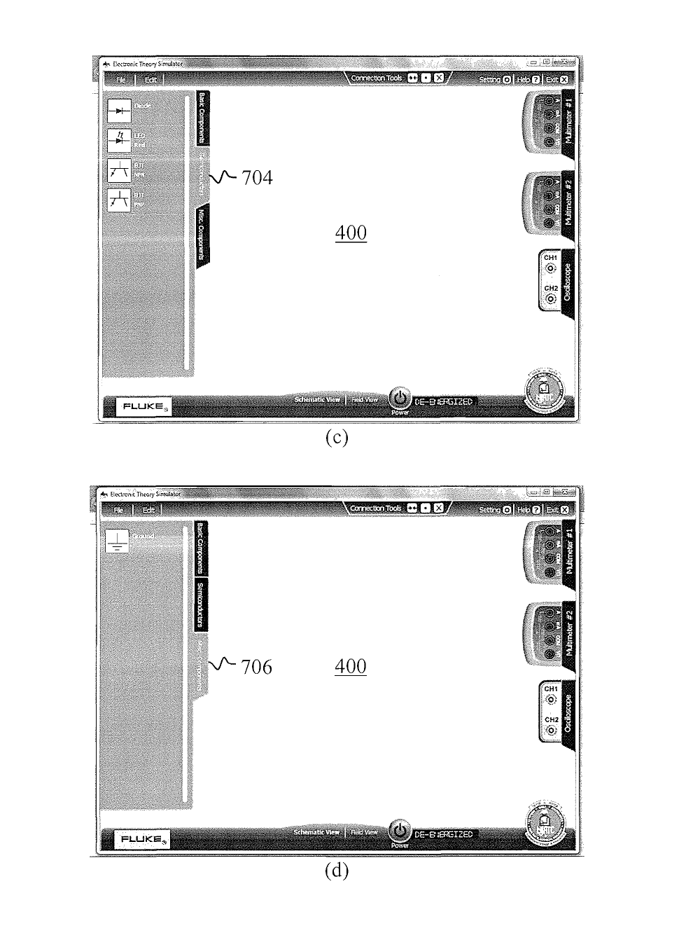

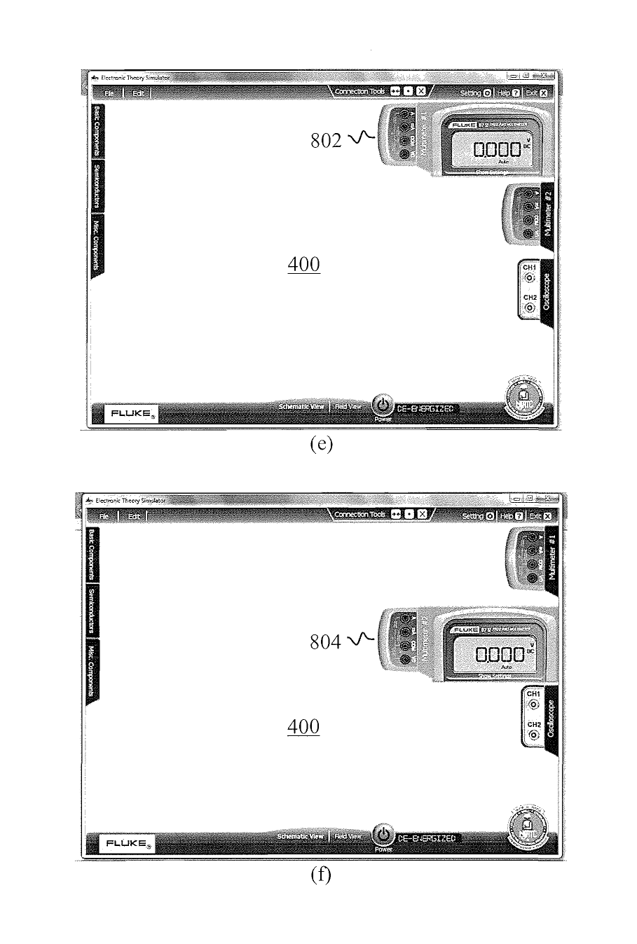

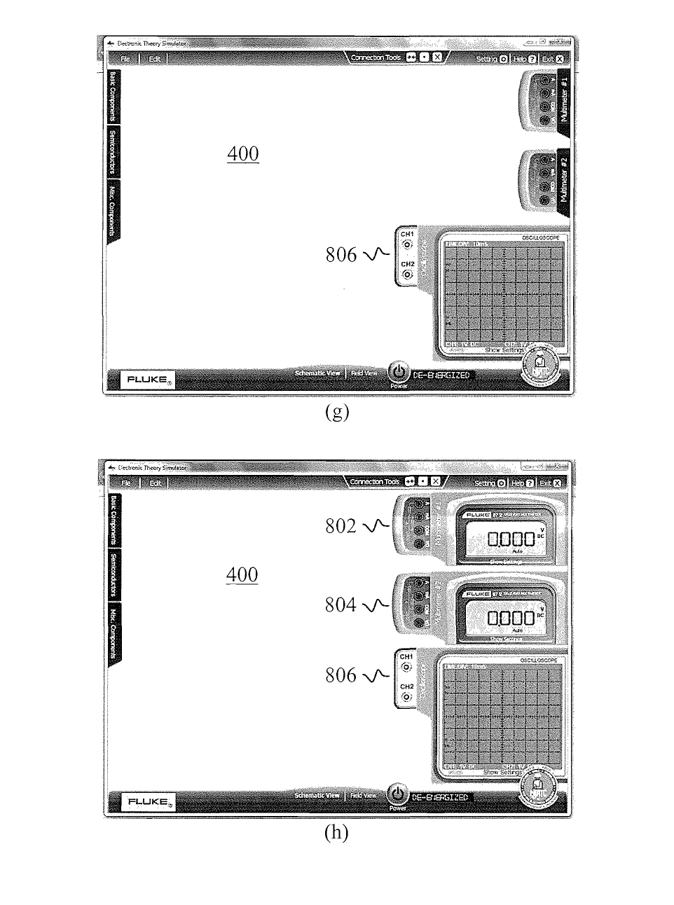

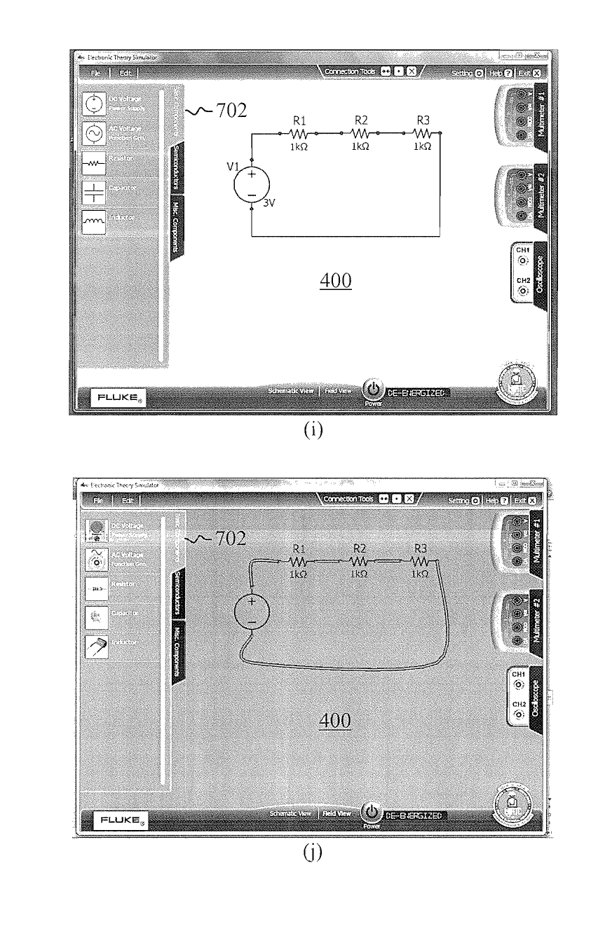

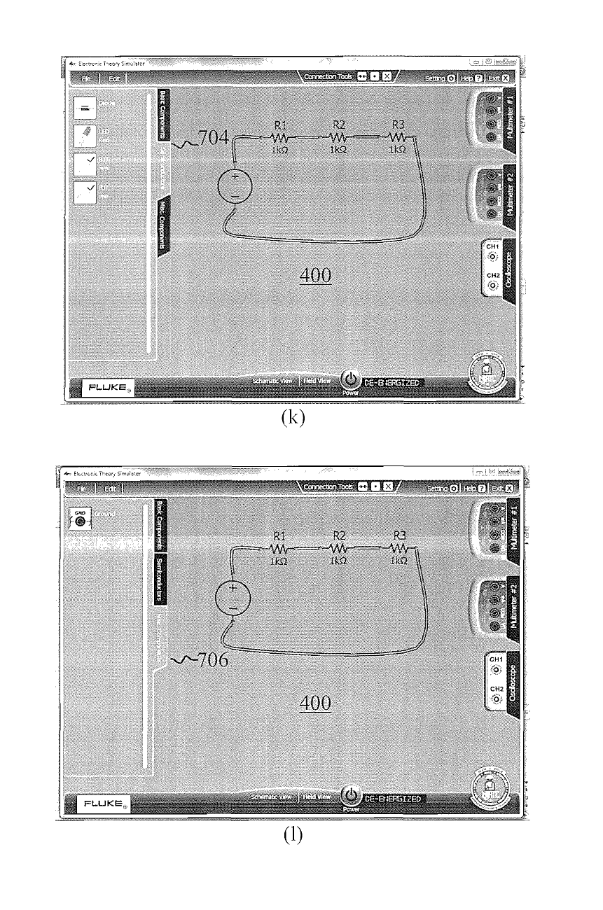

FIG. 3 is a flow chart of a method 300 illustrating steps in a process to create and test a simulated electronic circuit according to an exemplary embodiment of the present invention.

In a first step 310, the user can access the processor 110 to either resume work with a previously stored simulated electronic circuit, or create a new simulated electronic circuit at the LMS. The user may also be asked to input a password or satisfy another access restricting tool. Upon access to the processor 110, if the user wishes to resume work with a previously stored simulated electronic circuit, the stored circuit is retrieved and the user can proceed to any of steps 320-370. If the user wishes to create a new simulated electronic circuit, the user proceeds to step 320.

At step 320, the user enters commands using the user input to execute hardware and software of the processor 110 to create a project screen on the display 130, preferably as a work space bounded by a border and having a background color selectable by the user. In an exemplary embodiment of the present invention, the user can be required to save one project before opening or creating another, or multiple project screens can be created and the user can overlay each, or shift between each.

Once the project screen is established at step 320, the user can execute a command using the user input to execute hardware and software of the processor 110 to retrieve and display one or more libraries of the memory 120 on the display 130 at step 330. As noted above, the library of schematic components is displayed on the side of the screen or display, preferably as a box bounded by a border and having a background color selectable by the user, and distinguishable from the work space. The user can then execute commands using the user input to execute hardware and software of the processor 110 to drag and drop the components of the library anywhere on the project screen, displayed at a center of the screen. The user can place multiple occurrences of each type of component, and provide connections between components in a number of manners. For example, the user can drag and drop connections, or simply click one node or point in the circuit, and then another, to create a connection line between each. The user has the ability to select a color of the connections (i.e., red, black, blue, green, white, etc.), and has the ability to relocate a connection or erase it completely without affecting other connectivity.

The user can also select a particular model and value of the component at step 330, or a default value will be assigned where no values are entered by the user. For example, the user can execute a command using the user input to execute hardware and software of the processor 110 to retrieve and display one or more drop-down windows of each component or groups of components that allows the user to select a particular model and value of the component. The drop-down window can provide a library of a specific component models and values of the component for selection by the user.

At step 340, the user is also provided with a library of simulated power supplies and operating conditions (i.e., voltage, current, frequency, noise, etc.) that can be applied to the simulated electronic circuit. The user can execute commands using the user input to execute hardware and software of the processor 110 to again drag and drop the simulated power supplies and create the operating conditions of the library anywhere on the project screen, displayed at a center of the screen. A drop-down window of the simulated power supplies and operating conditions can be displayed at or near the component, and can provide a library of a specific power supply models and values for selection by the user, and can provide a library of operating conditions.

At step 350, the user is still further provided with a library of simulated testing devices or meters (i.e., voltage, current, etc.) that can be applied to the simulated electronic circuit and display detected values based on the circuit behaviors. The user can execute commands using the user input to execute hardware and software of the processor 110 to select a testing device or meter and again drag and drop the test leads of the simulated testing devices or meters of the library anywhere on the project screen, displayed at a center of the screen. A drop-down window of the simulated testing devices or meters can be displayed at or near the component, and can provide a library of a specific testing device or meter models and values for selection by the user.

Once the simulated electronic circuit is constructed and the simulated power supplies and operating conditions are applied, the ETS performs all necessary mathematical calculations utilizing the models and values of each component as entered by the user, or as valued by default where no user value is entered, to produce a behavioral model of the circuit at every node location. For example, power (P) dissipated in a resistor (r), where there is an applied voltage (v), is calculated by the ETS as follows:

Power(P)=current(i)×voltage(v),or

Power(P)=current(i)²×Resistance(r)

This, and any number of other circuit analysis equations, can be expressed in any number of ETS embodiments.

The user is able to measure various electrical quantities (i.e., volt, current, resistance, etc.) at nodes in the circuit using the simulated testing devices or meters at step 360. During testing, the ETS allows real-time changes to the simulated circuit, power supplies and operating conditions, and testing devices or meters, which measure various electrical quantities indicating these changes in real-time.

At any of steps 320-360, or as a final step 370, the user can save the material of the project screen, or print the material of the project screen. In an exemplary embodiment, the saved material can be titled and protected in some manner, such as through the use of a password or key. Likewise, the material can be shared with other users at step 365. Print functions allow the user to print the material of the project screen, and various reports and summaries thereof.

In an exemplary embodiment, the simulated electronic circuits can be configured and presented to illustrate fundamental electrical concepts. That is, the creation, configuration and testing of a simulated electronic circuit can be part of an educational curriculum. The following is a list of simulated electronic circuit exercises that can be performed by the ETS, but are not limited thereto.

### DC Labs:

### 1. Ohm's Law—Current

### 2. Ohm's Law—Voltage

### 3. Ohm's Law—Resistance

### 4. Power in DC Circuits

### 5. Resistance in Series Circuits

### 6. Current in Series Circuits

### 7. Batteries in Series Circuits

### 8. Voltage in Series Circuits

### 9. Voltage in Series Circuits—Adding

### 10. Voltage in Series Circuits—Opposing

### 11. Power, Current, and Resistance

### 12. Power, Voltage, and Resistance

### 13. Current in Parallel Circuits

### 14. Resistors of Equal Value in Parallel

### 15. Two Resistors of Unequal Value in Parallel

### 16. Resistors in Parallel

### 17. Voltage in Parallel Circuits

### 18. Power in Parallel Circuits

### 19. Resistance in Combination Circuits

### 20. Current in Combination Circuits

### 21. Voltage in Combination Circuits

### 22. Power in Combination Circuits

### 23. Voltage Divider Circuits

### 24. Current Divider Circuits

### 25. The Superposition Method

### 26. Kirchhoff's Voltage Law

### 27. Kirchhoff's Current Law

### 28. Kirchhoff's Laws—Single Source

### 29. Kirchhoff's Laws—Two Voltage Sources

### 30. Thevenin's Theorem I

### 31. Thevenin's Theorem II

### 32. Norton's Theorem

### AC Labs:

### 1. DC & AC Waves

### 2. Sine Waves—Voltages

### 3. Sine Waves—Definitions

### 4. Frequency and Inductive Reactance

### 5. Inductance and Inductive Reactance

### 6. Vectors

### 7. Series RL Circuits—Voltage

### 8. Series RL Circuits—Impedance

### 9. Series RL Circuits and Frequency

### 10. Capacitance

### 11. Capacitance

### 12. RC Time Constant

### 13. Capacitive Reactance and Frequency

### 14. Capacitive Reactance and Capacitance

### 15. Capacitors in Series

### 16. Capacitors in Parallel

### 17. Inductors in Series

### 18. Inductors in Parallel

### 19. Mutual Inductance—Series Connection

### 20. Mutual Inductance—Parallel Connection

### 21. Series RC Circuits—Voltage

### 22. Series RC Circuits—Impedance

### 23. Series RC Circuits—Current

### 24. Series RC Circuits and Frequency

### 25. Series RLC Circuits—Voltage

### 26. Series RLC Circuits—Impedance

### 27. Series RLC Circuits—Current

### 28. Series RLC Circuits—Resonance

### 29. Determining Q and Bandwidth of a Series RLC Circuit

### 30. Parallel RL Circuits—Impedance I

### 31. Parallel RL Circuits—Current

### 32. Parallel RL Circuits—Impedance II

### 33. Parallel RL Circuits and Frequency

### 34. Parallel RC Circuits—Impedance I

### 35. Parallel RC Circuits—Current

### 36. Parallel RC Circuits—Impedance II

### 37. Parallel RC Circuits and Frequency

### 38. Parallel RLC Circuits—Voltage and Current

### 39. Parallel RLC Circuits—Impedance

### 40. Parallel RLC Circuits—Resonance

### 41. Parallel Resonance—Q and Bandwidth

### 42. Series LC Circuits—Impedance

### 43. Series LC Circuits—Voltage

### 44. Parallel LC Circuits—Current

### 45. Parallel LC Circuits—Impedance

### 46. Combination RLC Circuits—Impedance

### 47. Combination RLC Circuits—Voltage

### 48. Combination RLC Circuits—Current

### 49. Scope Analysis of the RLC Circuits

### 50. Series Resonance

### 51. Determining the Q & Bandwidth of a Series RLC Circuit

### 52. Parallel Resonance

### 53. Parallel Resonance—Q & Bandwidth

### 54. Low Pass Filter Design

### 55. High Pass Filter Design

### 56. Band Pass Filter Analysis

### 57. Band Reject Filter Analysis

### 58. Power Factor

### 59. Power Factor Correction

### Semiconductor Labs:

### 1. Diode Characteristics

### 2. Zener Diode

### 3. Diodes

### 4. Rectifiers

### 5. Half-Wave Rectifier Circuits

### 6. Half-Wave Power Supply

### 7. Power Supply—Voltage Regulation

### 8. Power Supply—Ripple Voltage

### 9. Power Supplies—Full Wave Rectifiers

### 10. Power Supply—Bridge Rectifier

### 11. PNP Transistor Bias

### 12. NPN Transistor Bias

13. Determining Transistor Types with the DMM

### 14. Transistor Characteristic Curve

### 15. Transistor Current Relationships

### 16. Characteristics of the Unijunction Transistors

### 17. Common Emitter Transistor—Current Gain

### 18. Common Base Transistor—Current Gain

### 19. Common Collector Transistor—Current Gain

20. Amplifier Design using the Family of Curves

### 21. Transistor Switch

### 22. Transistor Bias

### 23. Determining Amplifier Gain

### 24. Amplifiers, Voltage Gain, and Signal Inversion

### 25. Amplifier Class

### 26. Controlling Gain of Operational Amplifiers

### 27. Differential Amplifier

### 28. Characteristics of SCRs

### 29. SCR Circuits I

### 30. SCR Circuits II

### 31. SCR Circuits III

32. Testing SCRs with the DMM

### 33. Testing a DIAC

34. Testing the TRIAC with the DMM

### 35. Light Dimmer Circuit

### 36. IC 555 Timer

### 37. Photoconductive Cells

### 38. Electronic Applications—Photoresistor

The following is a list of exemplary components that are provided by the ETS, but is not limited thereto.

Power Supplies:

### 1. (−V1) Negative Voltage Supply

### 2. (−V2) Negative Voltage Supply

### 3. (−V3) Negative Voltage Supply

### 4. (+V1) Positive Voltage Supply

### 5. (+V2) Positive Voltage Supply

### 6. (+V3) Positive Voltage Supply

### Diodes:

1. D1 (diode)
2. D2 (diode)
3. D3 (diode)
4. D4 (diode)
5. D5 (diode)

### 6. Zener (Diode)

### Resistors:

1. 100Ω (resistor)
2. 1KΩ (resistor)
3. 2.2KΩ (resistor)
4. 3.3KΩ (resistor)
5. 4.7KΩ (resistor)
6. 10KΩ (resistor)
7. 10KΩ (resistor)
8. 15KΩ (resistor)
9. 22KΩ (resistor)
10. 33KΩ (resistor)
11. 56KΩ (resistor)
12. 100KΩ (resistor)
13. 470KΩ (resistor)
14. 1MΩ (resistor)
15. 4.7MΩ (resistor)
16. 1KΩ (Adjustable resistor)
17. 10 KΩ (Adjustable resistor)
18. 100 KΩ (Adjustable resistor)
19. 1MΩ (Adjustable resistor)

### Transistors:

### 1. Q1 (PNP Transistor)

### 2. Q2 (PNP Transistor)

### 3. Q3 (PNP Transistor)

### 4. Q4 (NPN Transistor)

### 5. Q5 (NPN Transistor)

### 6. Q6 (NPN Transistor)

### 7. Q7 (NPN Transistor) Op-Amp Driver Amplifier

### Field Effect Transistors

### 1. Q8 (FET)

### 2. Q9 (FET)

### 3. Q10 (UJT)

### 4. Q11 (SCR)

### 5. Q12 (SCR)

### 6. Q13 (TRIAC)

### Capacitors:

### 1. 150 pF (Capacitor)

### 2. 220 pF (Capacitor)

### 3. 330 pF (Capacitor)

### 4. 1 μF (Capacitor)

### 5. 2 μF (Capacitor)

### 6. 5 μF (Electrolytic Capacitor)

### 7. 10 μF (Electrolytic Capacitor)

### 8. 0.01 μF (Capacitor)

### 9. 0.001 μF (Capacitor)

### 10. 0.25 μF (Capacitor)

### 11. 100 μF (Electrolytic Capacitor)

### 12. 200 μF (Electrolytic Capacitor)

### Inductors:

### 1. 50 mH (Inductor)

### 2. 10 mH (Inductor)

### 3. 25 mH (Inductor)

Misc. Components:

### 1. LED-1

### 2. Radio Coil-1

### 3. Buzzer

### 4. AC Supply T1

### 5. Photocell

### 6. Lamp

### 7. Varactor

### 8. DIAC

### 9. Momentary Switch (SPST)

### 10. Maintained Switch (SPST)

### 11. Maintained Switch (SPDT)

### 12. Momentary Switch (DPST)

### 13. Maintained Switch (DPST)

### 14. Maintained Switch (DPDT)

### 15. Thermionic Devices

16. Integrated Circuits (with relay contact component)

### 17. Speaker

The foregoing embodiments and advantages are merely exemplary, and are not to be construed as limiting the present invention. The present exemplary teachings can be readily applied to other types of apparatuses. Also, the description of the embodiments of the present invention is intended to be illustrative, and not to limit the scope of the invention, and many alternatives, modifications, and variations will be apparent to those skilled in the art without departing from the spirit and scope of the invention.

What is claimed is:

1. An interactive computer-based circuit modeling method to provide a user with an educational tool substantially duplicating and expanding a hardware-based breadboard educational tool, comprising the steps of:
simulating hardware functionality of a schematic component, a power supply and a testing device;
receiving inputs from a user to effectuate a hardware configuration using said schematic component, said power supply and said testing device;
simulating functionality of said configuration based upon user input attributes for each of said schematic component, said power supply and said testing device, and based upon connectivity of each of said schematic component, said power supply and said testing device; and
providing an output via said simulated testing device to said user based upon said simulated functionality of said configuration.

2. The method of claim 1, wherein the step of receiving inputs from a user to effectuate a hardware configuration using said schematic component, a power supply and a testing device comprises:
accessing a processor to either resume work with a previously stored configuration, or create a new configuration.

3. The method of claim 2, wherein the step of accessing said processor comprises inputting a password.

4. The method of claim 1, wherein the step of receiving inputs from a user to effectuate a hardware configuration using said schematic component, a power supply and a testing device comprises:
entering a command using a user input to create a project screen on a display, wherein said project screen comprises a schematic view and a field view.

5. The method of claim 4, wherein the step of receiving inputs from a user to effectuate a hardware configuration using said schematic component, a power supply and a testing device wherein:
said schematic view is provided as a first layer project screen, and said field view is provided as a second layer project screen, and
wherein said schematic view and said field view cumulatively reflect changes in respective views.

6. The method of claim 1, wherein the step of receiving inputs from a user to effectuate a hardware configuration using said schematic component, a power supply and a testing device comprises:
entering a command using a user input to retrieve and display one or more libraries of a schematic component, a power supply and a testing device on said display;
entering a command using a user input to drag and drop components of said libraries on said project screen; and
entering a command using a user input to drag and drop connections between components on said project screen.

7. The method of claim 1, wherein the step of simulating functionality of said configuration based upon user input attributes for each of said schematic component, said power supply and said testing device, comprises:
entering a command using a user input to assign an attribute to said schematic component, said power supply and said testing device of said project screen.

8. The method of claim 1, wherein the step of simulating functionality of said configuration, comprises:
executing mathematical calculations utilizing attributes of each schematic component, power supply and testing device as entered by the user, or by default where no user attributes are entered.

9. The method of claim 1, wherein the step of providing an output via said simulated testing device to said user based upon said simulated functionality of said configuration, comprises:
outputting electrical quantities of said configuration via said simulated testing device.

10. The method of claim 1, further comprising the step of:
saving said configuration, user input attributes for each of said schematic component, said power supply and said testing device, and said output.

11. An interactive computer-based circuit modeling simulator to provide a user with an educational tool substantially duplicating and expanding a hardware-based breadboard educational tool, comprising:
a processor for simulating hardware functionality of a schematic component, a power supply and a testing device;
a user input for receiving inputs from a user to effectuate a hardware configuration using said schematic component, said power supply and said testing device;
said processor further configured for simulating functionality of said configuration based upon user input attributes for each of said schematic component, said power supply and said testing device, and based upon connectivity of each of said schematic component, said power supply and said testing device; and
a display for providing an output via said simulated testing device to said user based upon said simulated functionality of said configuration.

12. The simulator of claim 11, wherein said processor is configured to store a configuration, or create a new configuration.

13. The simulator of claim 11, wherein said user input is configured to input a password and enter a command to create a project screen on the display, wherein said project screen comprises a schematic view and a field view.

14. The simulator of claim 13, wherein the schematic view is provided as a first layer project screen, and said field view is provided as a second layer project screen, and wherein said schematic view and said field view cumulatively reflect changes in respective views.

15. The simulator of claim 11, wherein said user input is configured to input a command to retrieve and display one or more libraries of a schematic component, a power supply and a testing device on said display, enter a command to drag and drop components of said libraries on said project screen, and enter a command to drag and drop connections between components on said project screen.

16. The simulator of claim 11, wherein said user input is configured to input a command to assign an attribute to said schematic component, said power supply and said testing device of said project screen.

17. The simulator of claim 11, wherein said processor is configured to execute mathematical calculations utilizing attributes of each schematic component, power supply and testing device as entered by the user, or by default where no user attributes are entered.

18. The simulator of claim 11, wherein the display is configured to output electrical quantities of said configuration via said simulated testing device.

19. An interactive computer-based circuit modeling method to provide a user with an educational tool substantially duplicating and expanding a hardware-based breadboard educational tool, comprising the steps of:
programming a circuit modeling simulator to duplicate a hardware-based breadboard educational tool and maintaining the circuit modeling simulator at a processor;
providing a user with a user input device for inputting commands to create and test a simulated electronic circuit on the duplicated hardware-based breadboard educational tool; and
providing a display for illustrating a simulated operation of the simulated electronic circuit on the duplicated hardware-based breadboard educational tool.

20. The method of claim 19, wherein the steps of for inputting commands to create and test a simulated electronic circuit on the duplicated hardware-based breadboard educational tool further comprises the steps of:
providing the user with a library of schematic components, displayed on the screen, that allows a user to drag and drop or otherwise move, place and connect the components anywhere on a project screen;
providing the user with a library of simulated power supplies and operating conditions that can be applied to the simulated electronic circuit; and
providing the user with a library of simulated testing devices or meters that display detected attributes based on the simulated electronic circuit behaviors.
